(19) United States
(12) Patent Application Publication
(10) Pub. No.: US 2026/0336053 A1
(43) Pub. Date: Oct. 29, 2026

(54) SYSTEMS, METHODS, AND STORAGE MEDIA FOR WORKPIECE POLISHING BASED ON SIX-AXIS FORCE SENSOR

(71) Applicant: CHENGDU QINCHUAN IOT TECHNOLOGY CO., LTD., Chengdu (CN)

(72) Inventors: Zehua SHAO, Chengdu (CN); Yong LI, Chengdu (CN); Chang SU, Chengdu (CN); Yunbai CHEN, Chengdu (CN)

(73) Assignee: CHENGDU QINCHUAN IOT TECHNOLOGY CO., LTD., Chengdu (CN)

(21) Appl. No.: 19/707,524

(22) Filed: Jun. 15, 2026

(30) Foreign Application Priority Data
May 9, 2026 (CN) 202610633388.1

(51) Int. Cl. B24B 37/005; B24B 55/02; B25J 9/16; B25J 11/00; B25J 13/08

(52) U.S. Cl. CPC B24B 37/005; B24B 55/02; B25J 9/163; B25J 9/1679; B25J 11/0065; B25J 13/085

(57) ABSTRACT

Disclosed is a system, a method, and a storage medium for workpiece polishing based on a six-axis force sensor. The system comprises a management platform and a perception and control platform. The management platform is configured to: determine mechanical response data of a current polishing region; determine a surface roughness of the current polishing region; determine, based on a workpiece type, a curvature of the current polishing region, the surface roughness, and a target roughness, target polishing parameters of the current polishing region; control an industrial robot to perform a polishing operation based on the target polishing parameters; and cyclically perform the above operations, and in response to a difference between the surface roughness of the current polishing region and the target roughness being less than a difference threshold, control the industrial robot to proceed to a next polishing region to perform the polishing operation.

### CROSS-REFERENCE TO RELATED APPLICATIONS

This application claims priority to Chinese Application No. 202610633388.1, filed on May 9, 2026, the entire contents of which are incorporated herein by reference.

### TECHNICAL FIELD

The present disclosure relates to the field of industrial polishing, and in particular to a system, a method, and a storage medium for workpiece polishing based on a six-axis force sensor.

### BACKGROUND

In high-end equipment fields such as aerospace, automobile manufacturing, and precision machinery, the surface polishing quality of complex curved workpieces, for example, impellers and wheel hubs, directly determines the operational accuracy, service life, and reliability of a product.

Conventional methods for workpiece polishing have many defects. On the one hand, conventional methods for workpiece polishing often use fixed preset polishing parameters and cannot dynamically adjust polishing parameters based on curvature changes and surface roughness of a workpiece region. Consequently, the conventional methods are prone to cause excessive polishing or insufficient polishing when dealing with complex curved surfaces. On the other hand, in an abnormal condition during a polishing process (e.g., polishing head wear, workpiece hard spots, and stress overload), the conventional methods for workpiece polishing lack real-time identification and adaptive adjustment capabilities. Thus, the conventional methods tend to cause workpiece scrap or equipment damage, making it difficult to cope with diversified workpieces and complex processing scenarios.

Therefore, it is desirable to provide a system, a method, and a storage medium for workpiece polishing based on a six-axis force sensor to achieve real-time feedback and adaptive control of a polishing process and improve polishing quality and efficiency.

### SUMMARY

One or more embodiments of the present disclosure includes a system for workpiece polishing based on a six-axis force sensor. The system for workpiece polishing based on the six-axis force sensor comprises a management platform and a perception and control platform, wherein the perception and control platform includes a six-axis force sensor and an industrial robot. The management platform is configured to: determine mechanical response data of a current polishing region based on the six-axis force sensor; determine a surface roughness of the current polishing region based on a workpiece type, current polishing parameters, and the mechanical response data; determine target polishing parameters of the current polishing region through a first model based on the workpiece type, a curvature of the current polishing region, the surface roughness, and a target roughness, wherein the target polishing parameters include a target polishing pressure, a target feed rate, and a target polishing angle, and the first model is a machine learning model; control the industrial robot to perform a polishing operation based on the target polishing parameters, and cyclically perform the above operations, and, in response to determining that a difference between the surface roughness of the current polishing region and the target roughness is less than a difference threshold, control the industrial robot to move to a next polishing region to perform the polishing operation, wherein the polishing operation includes: adjusting a joint torque of the industrial robot to apply the target polishing pressure; adjusting a driving power of the industrial robot to match the target feed rate; and adjusting a joint angle of the industrial robot to align with the target polishing angle.

One or more embodiments of the present disclosure provide a method for workpiece polishing based on a six-axis force sensor, implemented by a management platform of a system for workpiece polishing based on a six-axis force sensor. The method for workpiece polishing based on a six-axis force sensor comprises: determining mechanical response data of a current polishing region based on the six-axis force sensor; determining a surface roughness of the current polishing region based on a workpiece type, current polishing parameters, and the mechanical response data; determining target polishing parameters of the current polishing region through a first model based on the workpiece type, a curvature of the current polishing region, the surface roughness, and a target roughness, wherein the target polishing parameters include a target polishing pressure, a target feed rate, and a target polishing angle, and the first model is a machine learning model; controlling an industrial robot to perform a polishing operation based on the target polishing parameters, and cyclically performing the above operations, and in response to determining that a difference between the surface roughness of the current polishing region and the target roughness is less than a difference threshold, controlling the industrial robot to move to a next polishing region to perform the polishing operation, wherein the polishing operation includes: adjusting a joint torque of the industrial robot to apply the target polishing pressure; adjusting a driving power of the industrial robot to match the target feed rate; and adjusting a joint angle of the industrial robot to align with the target polishing angle.

One or more embodiments of the present disclosure provide a non-transitory computer-readable storage medium, storing computer instructions. When a computer reads the computer instructions in the storage medium, the computer executes the method for workpiece polishing based on the six-axis force sensor.

### BRIEF DESCRIPTION OF THE DRAWINGS

The present description will be further illustrated by way of exemplary embodiments, which will be described in detail with reference to the drawings. These embodiments are not intended to be limiting, and in these embodiments, like reference numerals denote like structures, wherein:

FIG. 1 is a block diagram illustrating an exemplary system for workpiece polishing based on a six-axis force sensor according to some embodiments of the present disclosure;

FIG. 2 is a flowchart illustrating an exemplary method for workpiece polishing based on a six-axis force sensor according to some embodiments of the present disclosure;

FIG. 3 is a schematic diagram illustrating an exemplary first model according to some embodiments of the present disclosure;

FIG. 4 is a schematic diagram illustrating an exemplary second model according to some embodiments of the present disclosure;

FIG. 5 is a schematic diagram illustrating an exemplary adjustment of a coolant injection flow rate according to some embodiments of the present disclosure.

### DETAILED DESCRIPTION

In order to more clearly illustrate the technical solutions of the embodiments of the present disclosure, a brief introduction to the accompanying drawings to be used in the description of the embodiments will be given below. It is apparent that the accompanying drawings in the following description are merely some examples or embodiments of the present disclosure, and for those skilled in the art, without inventive efforts, the present disclosure may also be applied to other similar scenarios based on the accompanying drawings. Unless obvious from the context or otherwise stated, the same reference numerals in the figures represent the same structures or operations.

It should be understood that the terms “system,” “device,” “unit,” and/or “module” used herein are a manner for distinguishing different components, elements, parts, portions, or assemblies of different levels. However, if other words can achieve the same purpose, the words may be replaced by other expressions.

As shown in the present disclosure and the claims, unless the context clearly indicates an exception, the words “a,” “an,” and/or “the” are not specific to the singular, and may also include the plurality. Generally speaking, the terms “comprising” and “including” merely suggest including explicitly identified steps and elements, and these steps and elements do not constitute an exclusive list, and a manner or device may also include other steps or elements.

Flowcharts are used in the present disclosure to illustrate operations performed by the system based on embodiments of the present disclosure. It should be understood that preceding or succeeding operations are not necessarily performed in precise order. Instead, the steps may be processed in reverse order or simultaneously. Meanwhile, other operations may also be added to the processes, or one or more operations may be removed from the processes.

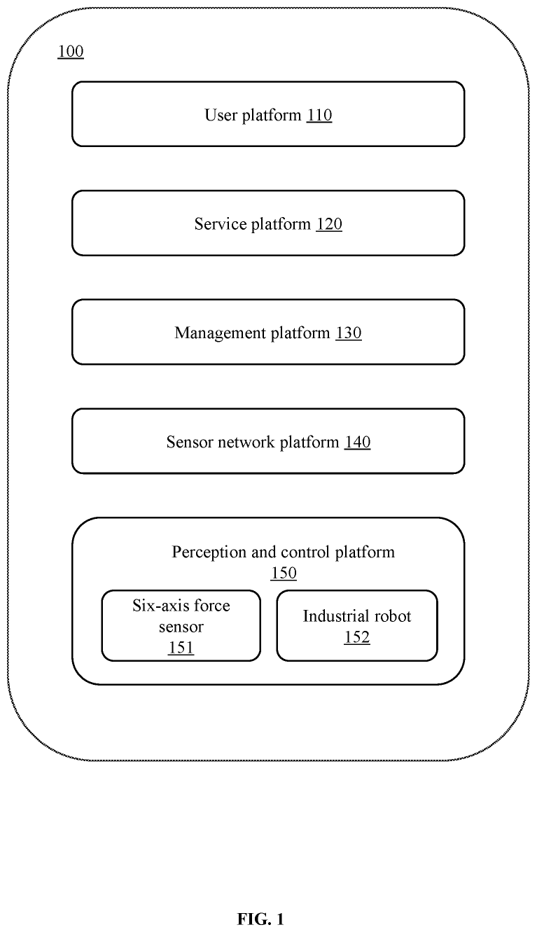

FIG. 1 is a block diagram illustrating an exemplary system for workpiece polishing based on a six-axis force sensor according to some embodiments of the present disclosure. A system 100 for workpiece polishing based on a six-axis force sensor refers to an automated system configured to perform a polishing operation on a workpiece.

In some embodiments, as shown in FIG. 1, the system 100 for workpiece polishing based on the six-axis force sensor may include a user platform 110, a service platform 120, a management platform 130, a sensor network platform 140, and a perception and control platform 150 communicatively connected in sequence.

The user platform 110 refers to an interactive platform for relevant personnel, such as process engineers, maintenance personnel, and production schedulers, or the like. In some embodiments, the user platform 110 may include at least one terminal device (e.g., a field operation terminal, a remote monitoring interface, an application, or the like).

The service platform 120 refers to a platform configured to transmit service requirements. In some embodiments, the service platform 120 may be configured as a server with communication functions and perform data interaction with the user platform 110 and the management platform 130. For example, the service platform 120 obtains data (e.g., polishing task requirements, workpiece CAD models, and target polishing parameters) uploaded by the relevant personnel from the user platform 110, and sends the data to the management platform 130. The service platform 120 may obtain the data (e.g., a current polishing progress, a current surface roughness, and operation status parameters (e.g., whether there is a fault or an anomaly) of an industrial robot from the management platform 130. The service platform 120 issues the data to the user platform 110 to ensure that the process engineers can monitor and adjust polishing parameters, and the maintenance personnel can handle anomalies in time.

The management platform 130 is a control unit configured to receive sensor data, perform data analysis and decision-making, and control the industrial robot to perform the polishing operation.

In some embodiments, the management platform 130 may be integrated into a processor. The processor is configured to coordinate and harmonize information transmission and collaboration among the platforms, and is a device that provides control and management functions for the system 100 for workpiece polishing based on the six-axis force sensor. In some embodiments, the processor may include, but is not limited to, a central processing unit (CPU), a graphics processing unit (GPU), a field-programmable gate array (FPGA), or the like.

In some embodiments, the management platform 130 is configured to determine mechanical response data of A current polishing region based on the six-axis force sensor; determine a surface roughness of the current polishing region based on a workpiece type, current polishing parameters, and the mechanical response data; determine target polishing parameters of the current polishing region through a first model based on the workpiece type, a curvature of the current polishing region, the surface roughness, and a target roughness, the target polishing parameters including a target polishing pressure, a target feed rate, and a target polishing angle, and the first model being a machine learning model; control the industrial robot to perform the polishing operation based on the target polishing parameters, and cyclically perform the above operations; and in response to determining that a difference between the surface roughness of the current polishing region and the target roughness is less than a difference threshold, control the industrial robot to move to a next polishing region to perform the polishing operation, the polishing operation including: adjusting a joint torque of the industrial robot to apply the target polishing pressure; adjusting a driving power of the industrial robot to match the target feed rate; and adjusting a joint angle of the industrial robot to align with the target polishing angle.

The sensor network platform 140 refers to a platform configured to perform sensing communication. In some embodiments, the sensor network platform 140 may be configured as an industrial Ethernet device, a 5G communication module, an edge computing gateway, or the like, and perform data interaction with the perception and control platform 150 and the management platform 130. For example, the sensor network platform 140 obtains the mechanical response data collected by the six-axis force sensor, and the operation status parameters (e.g., the joint torque, a motion speed, the joint angle, or the like) of the industrial robot from the perception and control platform 150, and uploads the data to the management platform 130 in real time. The sensor network platform 140 may obtain the data (e.g., target polishing parameters and a coolant injection flow rate) from the management platform 130. The sensor network platform 140 issues the data to the perception and control platform 150, thereby ensuring efficient and stable operation of the polishing system.

The perception and control platform 150 refers to a hardware execution platform configured to directly perform the polishing operation. In some embodiments, the perception and control platform 150 includes a six-axis force sensor 151 and an industrial robot 152.

The six-axis force sensor refers to a force sensor configured to collect and measure the mechanical response data. Compared with a traditional uniaxial force sensor, the six-axis force sensor can simultaneously detect forces or torques in a plurality of dimensional directions.

In some embodiments, two ends of the six-axis force sensor are respectively connected to a polishing head and the industrial robot to detect dynamic mechanical parameters of a contact interface between the polishing head and the workpiece during the polishing operation.

The industrial robot 152 refers to an automated mechanical device configured to perform the polishing operation, and includes a mechanical arm, the polishing head provided at an end of the mechanical arm, and matching driving mechanisms, or the like.

The polishing head refers to a tool component that directly contacts the workpiece and performs cutting, grinding, or polishing functions during the polishing operation. A material type of the polishing head may be determined according to actual application scenarios and requirements.

In some embodiments, the industrial robot 152 receives parameters (e.g., the joint torque, a motion speed, a rotation joint angle, or the like) issued by the management platform 130 to perform the polishing operation. The industrial robot 152 may feed back the data (e.g., a current polishing pressure, a current feed rate, a current joint angle, and a current rotation speed of the polishing head, or the like) to the management platform 130.

In some embodiments of the present disclosure, by the system 100 for workpiece polishing based on the six-axis force sensor, an information operation closed loop cany be formed among the functional platforms, and the system can operate in a coordinated and regular manner under the scheduling of the management platform 130, thereby realizing intelligent, precise, and efficient workpiece polishing processes.

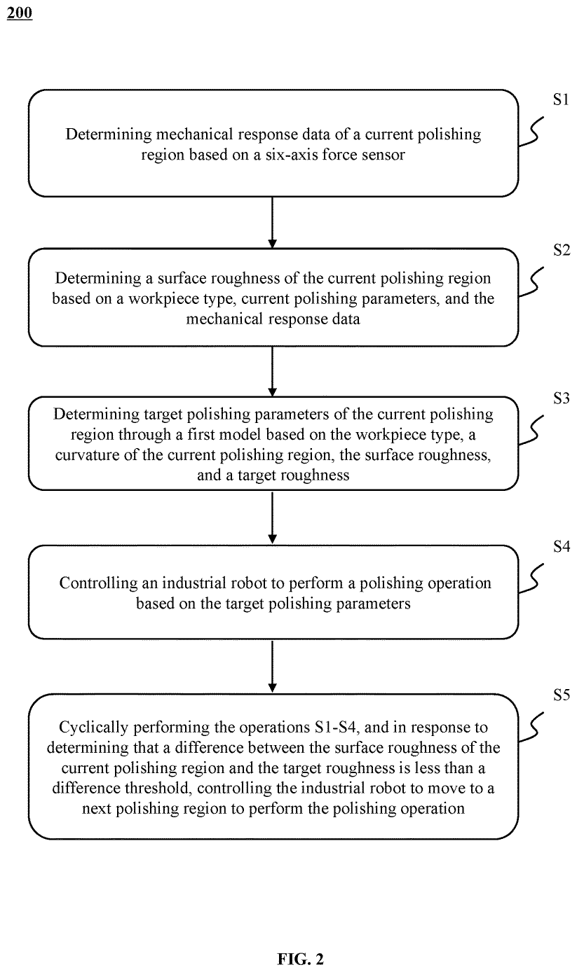

More descriptions regarding relevant functions of the above platforms may be found elsewhere in the present disclosure (e.g., FIGS. 2-5 and the related descriptions thereof).

It should be noted that the above description of the system 100 for workpiece polishing based on the six-axis force sensor and its platforms is merely for convenience of description, and should not limit the present disclosure to the scope of the disclosed embodiments. It can be understood that for those skilled in the art, after understanding the principle of the system, the platforms may be arbitrarily combined or a subsystem may be formed to connect with other platforms without departing from the principle. In some embodiments, the user platform 110, the service platform 120, the management platform 130, the sensor network platform 140, and the perception and control platform 150 disclosed in FIG. 1 may be different platforms in the system, or a single platform may implement the functions of two or more of the aboved platforms. For example, each platform may share a storage module, and each module may also respectively have its own storage module. Variations of this kind are all within the protection scope of the present disclosure.

FIG. 2 is a flowchart illustrating an exemplary method for workpiece polishing based on a six-axis force sensor according to some embodiments of the present disclosure. As shown in FIG. 2, the method for workpiece polishing based on the six-axis force sensor includes operations S1-S5. In some embodiments, the operations S1-S5 may be executed by a processor.

S1, determining mechanical response data of a current polishing region based on a six-axis force sensor.

The current polishing region is a local region on a surface of a current workpiece that needs to be polished. The current polishing region typically includes defects, such as parting lines, welds, or burrs, or the like. For example, the current polishing region may include a side wall of a wheel spoke of a wheel hub, an airfoil surface of a blade of an impeller, or the like.

In some embodiments, the processor may obtain the current polishing region uploaded by a process engineer from the user platform 110. The processor may determine a region having defects on the surface of the workpiece as a polishing region by identifying workpiece photos through an image recognition algorithm (e.g., a U-Net algorithm and a you only look once (YOLO) detection algorithm).

The mechanical response data refers to mechanical data reflecting a contact interaction between a polishing head and a workpiece. In some embodiments, the mechanical response data include linear forces (F_{X}, F_{Y}, F_{Z}) in three degrees of freedom and torques (M_{X}, M_{Y}, M_{Z}) of three rotational degrees of freedom. An X-axis and a Y-axis respectively correspond to two orthogonal tangential directions of the polishing head along a workpiece surface, a Z-axis is perpendicular to a plane of the X-axis and the Y-axis, and the Z-axis is parallel to a normal direction of the workpiece surface of the current polishing region. The processor may obtain the mechanical response data through the six-axis force sensor 151. More descriptions regarding the six-axis force sensor 151 may be found elsewhere in the present disclosure (e.g., FIG. 1 and the related descriptions thereof).

S2, determining a surface roughness of the current polishing region based on a workpiece type, current polishing parameters, and the mechanical response data.

The workpiece type is configured to reflect a type of a workpiece to be polished. In some embodiments, the workpiece type includes impellers, wheel hubs, gears, brackets, or the like. The processor may determine the workpiece type through the image recognition algorithm (e.g., the U-Net algorithm and the YOLO detection algorithm).

Polishing parameters refer to a set of parameters configured to control the polishing head to perform a polishing operation. The current polishing parameters refer to polishing parameters adopted at a current moment.

In some embodiments, the polishing parameters include a polishing pressure, a feed rate, and a polishing angle.

The polishing pressure refers to an acting force applied by the polishing head along a normal direction of a contact point. The polishing pressure may be represented as F_{Z} in the mechanical response data. The feed rate refers to a movement speed of the polishing head relative to a surface of a region of a workpiece being polished during a polishing process. The feed rate is positively correlated with an outer circumference of the current polishing head and a current rotational speed. The faster the feed rate, the higher the polishing efficiency of the polishing head, and the greater the material removal amount per unit time. The polishing angle refers to an angle between a rotation axis of the polishing head and a normal line of the current polishing region. Different polishing angles (e.g., point polishing, side polishing, or surface polishing) may affect a contact manner between the polishing head and the workpiece.

In some embodiments, the processor may determine the polishing pressure (F_{Z}) based on the six-axis force sensor; determine the feed rate based on a tachometer at the polishing head and the outer circumference of the polishing head; and determine the polishing angle based on a gyroscope or an angle sensor at the polishing head.

The surface roughness is configured to characterize a microscopic undulation degree of the surface of the workpiece. In some embodiments, the surface roughness is represented as an arithmetic mean deviation of the profile (Ra). The lower the Ra value, the smoother the surface of the workpiece.

In some embodiments, the processor may determine the surface roughness of the current polishing region through a plurality of ways. For example, the processor may consult a first preset table that is pre-constructed, and obtain the surface roughness of the current polishing region through similarity matching.

The first preset table includes a correspondence between historical workpiece types, historical polishing parameters, historical mechanical response data, and historical surface roughness. The processor collects a large amount of historical polishing records to construct the first preset table. Each historical polishing record includes the historical workpiece types, the historical polishing parameters, the historical mechanical response data, and the historical surface roughness actually measured by a roughness measuring instrument after historical polishing is finished.

When consulting the first preset table, the processor takes a current workpiece type, real-time polishing parameters, and the mechanical response data as a matching basis, retrieves a historical polishing record having a highest similarity from the first preset table, and determines a historical surface roughness corresponding to the historical polishing record as the surface roughness of the current polishing region. The processor may determine the similarity through cosine similarity, or the like.

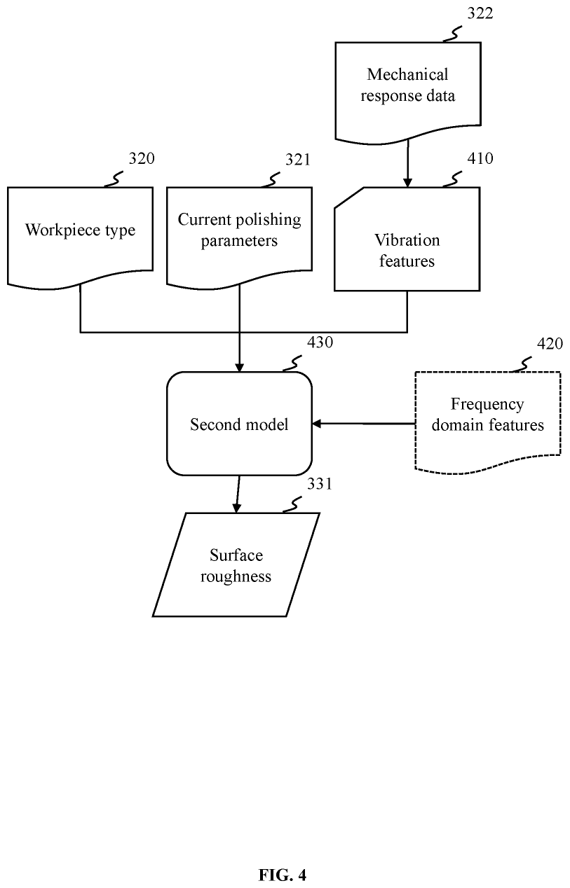

In some embodiments, the processor may determine the surface roughness of the current polishing region through a second model. More descriptions regarding the second model may be found elsewhere in the present disclosure (e.g., FIG. 4 and the related descriptions thereof).

S3, determining target polishing parameters of the current polishing region through a first model based on the workpiece type, a curvature of the current polishing region, the surface roughness, and a target roughness.

The curvature is configured to measure a bending degree of the current polishing region of the workpiece. The larger the curvature is, the more intensely a curved surface of the current polishing region bends, and the difficulty in fitting the polishing head to the curved surface increases accordingly. The processor may read a workpiece computer-aided design (CAD) model, and perform surface fitting and curvature determination on the current polishing region through approaches such as Weingarten mapping, Mesh Laplacian, or the like, to determine the curvature.

The target roughness refers to a surface roughness that needs to be achieved during a workpiece polishing process. In some embodiments, the target roughness may be preset and determined based on actual application scenarios and requirements. Different polishing task requirements (e.g., a mirror polishing task and a deburring task) may have different target roughness preset.

The target polishing parameters refer to polishing parameters for polishing the current polishing region to the target roughness. Since parameters including the surface roughness of the current polishing region and a wear degree of the polishing head are dynamically changing during the polishing process, the processor needs to dynamically adjust the current polishing parameters to ensure that the target polishing parameters balance polishing efficiency and polishing quality.

In some embodiments, the target polishing parameters include a target polishing pressure, a target feed rate, and a target polishing angle. More descriptions regarding the polishing pressure, the feed rate, and the polishing angle may be found in the preceding related descriptions.

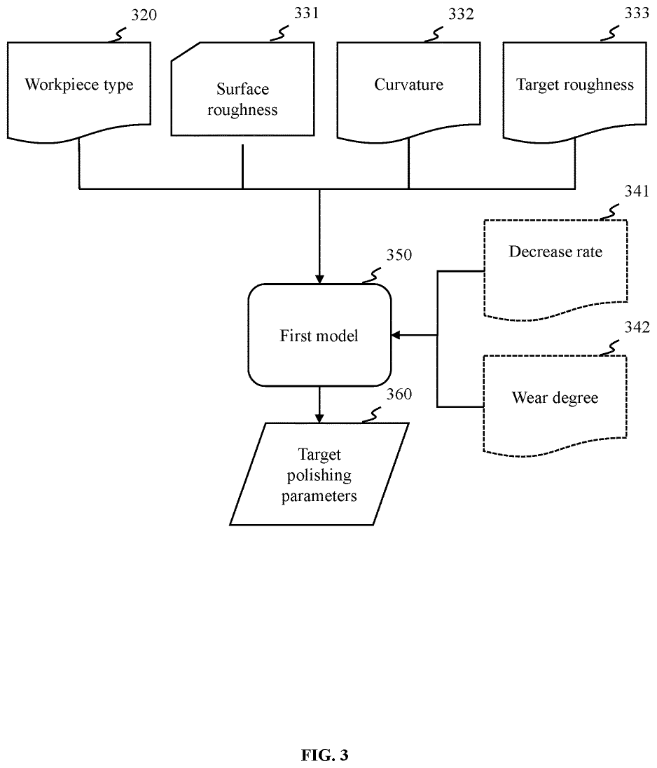

FIG. 3 is a schematic diagram illustrating an exemplary first model according to some embodiments of the present disclosure.

A first model 350 refers to a prediction model configured to predict the target polishing parameters. In some embodiments, the first model may be a machine learning model. For example, the machine learning model may be any one of a neural networks (NN) model or other customized model structures, or the like, or any combination thereof.

In some embodiments, an input of the first model 350 includes a workpiece type 320, a curvature 332 of the current polishing region, a surface roughness 331, and a target roughness 333; and an output of the first model 350 includes target polishing parameters 360 of the current polishing region. More descriptions regarding the workpiece type and the surface roughness may be found elsewhere in the present disclosure (e.g., the operation S2 and the related descriptions thereof).

In some embodiments, the input of the first model further includes a decrease rate 341 of the surface roughness and a wear degree 342 of the polishing head.

The decrease rate 341 of the surface roughness refers to a decrease of the surface roughness per unit time. The faster the decrease rate, the higher the material removal efficiency of a current polishing process.

The decrease rate 341 of the surface roughness may be used to determine whether the current polishing process is operating normally. If the decrease rate is too low, it indicates that hard points may exist in the current polishing region, or the polishing head is passivated, causing an insufficient cutting force. If the decrease rate is too fast, it indicates that there may be a risk of over-polishing, and the polishing parameters need to be adjusted in time to avoid damaging the surface of the workpiece.

In some embodiments, the processor may perform continuous detection and acquisition of the surface roughness, and plot a change curve of the surface roughness gradually decreasing over time. An instantaneous slope at a certain moment on the change curve refers to the decrease rate of the surface roughness at the corresponding moment. The processor may use the decrease rate within a preset time range as an input of the first model.

The wear degree 342 of the polishing head is used to measure a degree of service life degradation of the polishing head caused by long-term use. The higher the wear degree of the polishing head, the more severe material wear of the polishing head, and the shorter remaining service life. The wear degree of the polishing head may be expressed as a remaining thickness of the polishing head.

The wear degree 342 of the polishing head may be used to determine processing stability and parameter adaptability of the current polishing process. If the wear degree is too high, it indicates that the cutting capability of the polishing head may be degraded, causing unstable polishing quality. At this time, it needs to replace the polishing head and/or adjust the polishing parameters in time to compensate for loss of cutting capability caused by wear.

In some embodiments, the processor may measure the remaining thickness of the polishing head during an interval of the polishing operation through an industrial camera and/or a laser rangefinder to determine the wear degree 342 of the polishing head.

In some embodiments of the present disclosure, by determining the decrease rate of the surface roughness and the wear degree of the polishing head as the input of the first model, the system for workpiece polishing based on the six-axis force sensor is facilitated to identify abnormal situations such as hard points, over-polishing, and passivation of the polishing head during the polishing process in time, thereby optimizing polishing efficiency, extending tool life, and ensuring stability and consistency of workpiece surface quality.

In some embodiments, the processor may train to obtain the first model based on a large number of first training samples with first labels. The first training samples with the first labels may be constructed based on historical polishing records. For example, the processor may obtain a plurality of sets of historical polishing records and filter them by only retaining preferred polishing records with good polishing effect and normal operation of the industrial robot. The processor determines historical workpiece types, historical curvatures, historical surface roughness, historical target roughness, historical decrease rates, and historical wear degrees of the preferred polishing records as the first training samples, and determines the historical polishing parameters of the preferred polishing records as the first labels. The good polishing effect refers to that a difference between the surface roughness of the workpiece and the historical target roughness is less than a preset difference threshold after a historical polishing process is finished. The normal operation of the industrial robot refers to that the industrial robot has not experienced abnormalities such as overload, error reporting, and vibration, or the like, during the historical polishing process, and has always operated normally and stably.

In some embodiments, a training process of the first model includes: forming a first training sample set from the plurality of first training samples with the first labels mentioned above, and performing multiple iterations based on the first training sample set. At least one of the multiple iterations includes: selecting one or more first training samples from a training dataset, inputting the one or more first training samples into an initial first model, and obtaining corresponding model prediction outputs; substituting the model prediction outputs and the first labels corresponding to the first training samples into a predefined loss function formula, and determining a value of the loss function; and iteratively updating model parameters of the initial first model based on the value of the loss function by using gradient descent, or the like. When iteration termination conditions such as the loss function converging or a count of iterations reaching a preset iteration count threshold are met, the iteration is terminated, thereby obtaining a trained first model.

S4, controlling an industrial robot to perform a polishing operation based on the target polishing parameters.

The polishing operation refers to a process in which the processor performs grinding, polishing, or other processing on the workpiece surface by controlling movement and force application of the industrial robot.

In some embodiments, the polishing operation includes: adjusting a joint torque of the industrial robot to apply a target polishing pressure; adjusting a driving power of the industrial robot to match a target feed rate; and adjusting a joint angle of the industrial robot to align with a target polishing angle.

The joint torque refers to a torsional torque output by a driving motor at each of rotating joints of a robotic arm of the industrial robot. The greater the joint torque, the greater the pressure applied to the workpiece by the robotic arm through the polishing head, and the greater the target polishing pressure.

The driving power refers to an output power of a power unit of the industrial robot, where the power unit is configured to provide power for rotation of the polishing head. The greater the driving power, the greater the power provided to the polishing head by the industrial robot, and the faster the rotation speed of the polishing head.

The joint angle refers to a bending angle of the robotic arm of the industrial robot. By changing the bending angle of the robotic arm, a contact manner and a contact area of the polishing head with the current polishing region can be changed. For example, when an axis of the polishing head is perpendicular to the current polishing region, the contact area of the polishing head with the current polishing region is minimized, which is applicable to polishing scattered sandy protrusions; when the axis of the polishing head is parallel to the current polishing region, the contact area of the polishing head with the current polishing region is maximized, which is applicable to polishing large-area rough surfaces.

In some embodiments, the processor may control the industrial robot to perform the polishing operation by a plurality of ways. When the industrial robot supports direct input of the target polishing parameters, the processor may directly send the target polishing parameters to the industrial robot, and the industrial robot automatically adjusts the joint torque, the driving power, and the joint angle through a built-in proportional-integral-derivative (PID) controller. When the industrial robot does not support direct input of the target polishing parameters, the processor may determine a fine-tuning direction (decrease or increase) of the joint torque, the driving power, and the joint angle based on a magnitude relationship between the current polishing parameters and the target polishing parameters.

The processor progressively adjusts the current polishing parameters based on the fine-tuning direction and a preset step size until the current polishing parameters converge within a preset error range allowed by the target polishing parameters to perform the polishing operation. Merely by way of example, when a current feed rate among the current polishing parameters is less than the target feed rate, the processor may determine that the fine-tuning direction of the driving power is an increase, and gradually increase the driving power and monitor the current feed rate based on the preset step size in real time. In response to the current feed rate converging within the preset error range allowed by the target feed rate, the adjustment of the target feed rate is completed.

The processor may adjust the joint torque of the industrial robot by referring to the adjustment manner mentioned above, thereby adjusting the current polishing pressure to the target polishing pressure; and adjust the joint angle of the industrial robot, thereby adjusting the current polishing angle to the target polishing angle.

In S5, cyclically performing the operations S1-S4, and in response to determining that a difference between the surface roughness of the current polishing region and the target roughness is less than a difference threshold, controlling the industrial robot to move to a next polishing region to perform the polishing operation.

The difference threshold is a condition for determining whether the current polishing region is finished with polishing. There are known to be two cases for the difference between the surface roughness of the current polishing region and the target roughness: the difference being less than the difference threshold and the difference being not less than the difference threshold. In response to the difference being less than the difference threshold, the processor may consider that the current polishing region is finished with polishing. In this case, the processor may control the industrial robot to move the polishing head at an end of the robotic arm of the industrial robot to the next polishing region, thereby repeating the operations S1-S4 to perform the polishing operation.

In some embodiments, the difference threshold may be preset and determined based on actual application scenarios and requirements.

According to some embodiments of the present disclosure, the system for workpiece polishing based on the six-axis force sensor and the method for workpiece polishing based on the six-axis force sensor are provided. The system and the method are capable of achieving intelligent feedback and adaptive adjustment of the polishing process, automatically adjusting the polishing parameters for different workpiece regions, effectively solving problems of over-polishing or under-polishing that easily occur in traditional constant-force polishing when facing uneven material hardness or drastic changes in surface curvature, thereby improving polishing quality and efficiency.

FIG. 4 is a schematic diagram illustrating an exemplary second model according to some embodiments of the present disclosure. In some embodiments, the processor is configured to: determine vibration features 410 based on mechanical response data 322, where the vibration features 410 include friction vibration features and contact disturbance features; and determine the surface roughness 331 of a current polishing region through a second model 430 based on the workpiece type 320, current polishing parameters 321, and the vibration features 410, where the second model 430 is a machine learning model.

The vibration features 410 refer to signal fluctuation features extracted from the mechanical response data and configured to reflect specific patterns or regularities of mechanical vibration signals in a time domain or a frequency domain. The vibration features include the friction vibration features and the contact disturbance features. More descriptions regarding the mechanical response data may be found elsewhere in the present disclosure (e.g., the operation S1 and the related descriptions thereof).

The friction vibration features are configured to characterize tangential force fluctuations when movement of a polishing head is obstructed. The higher the surface roughness of a workpiece, the more drastic the resistance fluctuations borne by the polishing head when moving in a tangential direction, and the greater the friction vibration features. The tangential direction refers to a direction in which the polishing head moves on a horizontal plane of the current polishing region.

In some embodiments, the processor may determine a resultant tangential force Fₜₐₙ₍ₜ₎ based on linear forces F_{X(t)} and F_{Y(t)} at a single moment t. The resultant tangential force Fₜₐₙ₍ₜ₎ is a vector synthesis result of the linear forces F_{X} and F_{Y} at the single moment t. The resultant tangential force Fₜₐₙ₍ₜ₎ is positively correlated with the linear forces F_{X(t)} and F_{Y(t)}.

In some embodiments, the resultant tangential force Fₜₐₙ₍ₜ₎ at the single moment t may be expressed as: Fₜₐₙ₍ₜ₎=\sqrt{F_{X(t)}²+F_{Y(t)}²}.

In some embodiments, the processor may determine the resultant tangential force

$${\sum }_{t = {t}_{0}}^{{t}_{n}} {F}_{tan ( t )}$$

within a preset time window t₀-tₙ through the above manner. Then, a high-pass filter is applied to

$${\sum }_{t = {t}_{0}}^{{t}_{n}} {F}_{tan ( t )}$$

to filter out low-frequency components thereof, and then a root mean square (RMS) value of

$${\sum }_{t = {t}_{0}}^{{t}_{n}} {F}_{tan ( t )}$$

within the preset time window is obtained, and the obtained RMS value is used as the friction vibration feature of the preset time window. A cutoff frequency of the high-pass filter may be preset based on prior experience.

The contact disturbance features are configured to characterize torque fluctuations caused by an eccentric force applied to the polishing head. When the polishing head moves in the tangential direction, once it contacts protruding or recessed morphological defects (e.g., burrs, edges, or the like), the polishing head instantaneously bears an additional reaction force, causing a disruption of an original force equilibrium state and the polishing head to undergo the eccentric force, thereby leading to abnormal fluctuations of a resultant torque. The more the count of morphological defects and the greater the degree of protrusions or recesses, the more drastic the reaction force, and the greater the contact disturbance features.

In some embodiments, the processor may determine the resultant torque Mᵣₑₛ₍ₜ₎ based on torques M_{X(t)}, M_{Y(t)}, and M_{Z(t)} in the mechanical response data at the single moment t. The resultant torque Mᵣₑₛ₍ₜ₎ is a vector synthesis result of the torques M_{X(t)}, M_{Y(t)}, and M_{Z(t)} at the single moment t. The resultant torque Mᵣₑₛ₍ₜ₎ is positively correlated with the torques M_{X(t)}, M_{Y(t)}, and M_{Z(t)} in the mechanical response data at the single moment t.

In some embodiments, the resultant torque Mᵣₑₛ₍ₜ₎ at the single moment t may be expressed as: Mᵣₑₛ₍ₜ₎=\sqrt{M_{X(t)}²+M_{Y(t)}²+M_{Z(t)}²}.

In some embodiments, the processor may determine the resultant torque

$${\sum }_{t = {t}_{0}}^{{t}_{n}} {M}_{rest ( t )}$$

within the preset time window t₀-tₙ through the above manner. Then, the high-pass filter is applied to

$${\sum }_{t = {t}_{0}}^{{t}_{n}} {M}_{rest ( t )}$$

to filter out the low-frequency components thereof, and then the RMS value of

$${\sum }_{t = {t}_{0}}^{{t}_{n}} {M}_{rest ( t )}$$

within the preset time window is obtained, and the obtained RMS value is used as the contact disturbance feature of the preset time window. The cutoff frequency of the high-pass filter may be preset based on prior experience.

The second model 430 is a prediction model for predicting the surface roughness. In some embodiments, the second model may be a machine learning model, such as any one of a neural networks (NN) model, other customized model structures, or the like, or any combination thereof.

In some embodiments, an input of the second model 430 includes the workpiece type 320, the current polishing parameters 321, and the vibration features 410, and an output of the second model 430 includes the surface roughness 331 of the current polishing region. More descriptions regarding the workpiece type 320 and the surface roughness 331 may be found elsewhere in the present disclosure (e.g., the operation S2 and the related descriptions thereof).

In some embodiments, the input of the second model 430 further includes frequency domain features 420. The processor is configured to: determine a power spectral density function based on the mechanical response data; and determine the frequency domain features based on the power spectral density function, where the frequency domain features include a spectral centroid, a spectral entropy, and a band energy ratio.

The power spectral density function is a function that reflects a power distribution of the mechanical response data at different frequencies. A horizontal axis of the power spectral density function is frequency (Hz), and a vertical axis of the power spectral density function is power (N²/Hz) within a unit frequency bandwidth.

In some embodiments, the processor determines the resultant tangential force within the preset time window t₀-tₙ based on the mechanical response data. Then, the high-pass filter is applied to the resultant tangential force

$${\sum }_{t = {t}_{0}}^{{t}_{n}} {F}_{tan ( t )}$$

to filter out low-frequency components thereof. Fast Fourier Transform (FFT) is then performed, followed by obtaining a squared magnitude of an FFT result. After normalization, the power spectral density function within the preset time window t₀-tₙ is obtained. The cutoff frequency of the high-pass filter may be preset based on prior experience. More descriptions regarding determining the resultant tangential force

$${\sum }_{t = {t}_{0}}^{{t}_{n}} {F}_{tan ( t )}$$

and applying the high-pass filter may be found in the preceding related descriptions.

In some embodiments, the processor may use spectrum analysis techniques, such as the Welch, an autoregressive (AR) model, Wavelet Transform, or the like, to determine the power spectral density function.

The frequency domain features 420 are configured to reflect a distribution of signal energy across different frequency ranges. The frequency domain features include the spectral centroid, the spectral entropy, and the band energy ratio.

The spectral centroid is configured to reflect a center frequency of a power concentration region of the entire power spectral density function.

The spectral entropy is configured to reflect a degree of dispersion of power of the power spectral density function in a frequency dimension. The higher the spectral entropy, the more power tends to be evenly dispersed across most frequency ranges; the lower the spectral entropy, the more power is highly concentrated in a few specific frequency ranges.

The band energy ratio is configured to reflect a weight of power in a certain frequency range within the entire power spectrum. The higher the band energy ratio of a certain frequency range, the greater the influence of the frequency range on the entire power spectrum.

In some embodiments, the band energy ratio may reflect hardness features of the current polishing region. The greater the band energy ratio of a high frequency range, the greater the proportion of high-frequency disturbances in the polishing process, indicating that a hardness of the current polishing region is higher, and there may be local abnormal morphologies, such as hard spots, burrs, or the like. The high frequency range may be preset and determined based on prior experience.

In some embodiments, the processor may determine the frequency domain features through a plurality of ways. For example, the processor may take the power spectral density function as an input, and output the spectral centroid by standard integration, discrete summation, or the like; output the spectral entropy by Shannon spectral entropy, normalized spectral entropy, or the like; and output the band energy ratio by discrete summation, weighted average, or the like.

According to some embodiments of the present disclosure, by introducing the frequency domain features such as the spectral centroid, the spectral entropy, and the band energy ratio as inputs to the second model, the model is enabled to more comprehensively identify dynamic characteristics of polishing signals, significantly improving the accuracy of surface roughness inversion and adaptive capability to complex processing states, thereby effectively optimizing polishing process quality and efficiency.

In some embodiments, the processor may train the second model based on a large number of second training samples with second labels. The processor obtains preferred polishing record for constructing the second training samples, and divides, based on a count of interruption measurements of the preferred polishing records, the preferred polishing records into a plurality of sub-records corresponding to the count of interruption measurements. For each sub-record, a historical workpiece type, historical polishing parameters, historical friction vibration features, historical contact disturbance features, and historical frequency domain features corresponding to the polishing stage are determined as the second training samples. A historical surface roughness measured at the end of the polishing stage is determined as the corresponding second label. More descriptions regarding the preferred polishing records and its acquisition operations may be found in the related descriptions of the first training samples.

Merely by way of example, for a preferred polishing record with a count of interruption measurements being 3, the polishing process may be expressed as: polishing I→interruption measurement I→polishing II→interruption measurement II→polishing III→interruption measurement III→polishing finished. The processor may divide the preferred polishing record into three sub-records based on the count of interruption measurements, which are respectively: a first sub-record (polishing I→interruption measurement I), a second sub-record (polishing II→interruption measurement II), and a third sub-record (polishing III→interruption measurement III). The processor uses a historical workpiece type inherent to the workpiece, the historical polishing parameters of polishing I, the historical friction vibration features, the historical contact disturbance features, and the historical frequency domain features as the second training samples for the first sub-record, and uses the historical surface roughness collected by interruption measurement I as the second label for the first sub-record. The processor may determine the second training samples with the second labels for the second sub-record and for the third sub-record through the above manner, thereby achieving construction of a plurality of second training samples with the second labels based on the preferred polishing record.

The operations for the processor to train an initial second model to obtain the second model based on the second training samples with the second labels are similar to the operations for training the initial first model to obtain the first model based on the first training samples with the first labels. More descriptions may be found in the preceding related descriptions.

According to some embodiments of the present disclosure, by introducing the friction vibration features and the contact disturbance features, dynamic changes of surface states during polishing can be more accurately reflected, thereby improving real-time performance and accuracy of surface roughness evaluation.

In some embodiments, a material of the polishing head is polyurethane, and an interior of the polishing head is filled with a magnetorheological fluid and integrated with an electromagnetic coil.

In some embodiments, the material of the polishing head is the polyurethane, such as polyether type polyurethane, polyester type polyurethane, polyimide type polyurethane, polyurea type polyurethane, or the like. The polyurethane may be mixed with micro-powders such as silicon carbide, aluminum oxide, or the like. The polyurethane may include cross-linking agents such as methylenediphenyl diisocyanate (MDI), or the like, to further improve the wear resistance of the polishing head.

In some embodiments, the polishing head is internally provided with a cavity, and the cavity is filled with the magnetorheological fluid and integrated with the electromagnetic coil.

The magnetorheological fluid refers to a fluid that is sensitive to a magnetic field. The magnetorheological fluid is generally composed of soft magnetic particles, a carrier liquid, and a stabilizer.

The electromagnetic coil refers to a coil device that generates the magnetic field by being energized. The electromagnetic coil may be configured to generate a controllable magnetic field. Under the action of the magnetic field, the magnetorheological fluid may be transformed from its low viscosity fluid state to a high viscosity pseudo-solid state to adjust a viscosity of the magnetorheological fluid. By increasing or decreasing the current of the electromagnetic coil, the viscosity of the magnetorheological fluid is adjusted, thereby indirectly controlling a stiffness of the polishing head.

The stiffness of the polishing head refers to an ability of the polishing head to resist deformation. The greater the stiffness of the polishing head, the harder the polishing head, and the higher the polishing efficiency; the lower the stiffness of the polishing head, the softer the polishing head, and the more easily the polishing head conforms to the current polishing region.

A curvature threshold refers to a critical parameter for determining a magnitude of the curvature of the current polishing region. The curvature threshold may be determined based on prior experience.

In some embodiments, there are two known cases: the curvature being greater than the curvature threshold, and the curvature being less than or equal to the curvature threshold. In response to determining that the curvature is greater than the curvature threshold, the management platform determines a current decrement of the electromagnetic coil to reduce the stiffness of the polishing head, soften the polishing head, and make the polishing head conform to the current polishing region; and in response to determining that the curvature is less than or equal to the curvature threshold, the management platform determines a current increment of the electromagnetic coil to increase the stiffness of the polishing head, harden the polishing head, and make the polishing head cut the current polishing region.

In some embodiments, the management platform may determine the current decrement and the current increment of the electromagnetic coil through a plurality of ways. For example, the management platform may preset the current decrement and the current increment of the electromagnetic coil based on prior experience. For example, the management platform may establish a second preset table. The second preset table includes a corresponding relationship among the curvature, the curvature threshold, and different current decrements or current increments. By looking up the second preset table, the management platform may determine a present current decrement or a present current increment based on a current curvature and the curvature threshold. The corresponding relationship may be that: the greater the magnitude by which the curvature exceeds the curvature threshold, the greater the current decrement; and the greater the magnitude by which the curvature is less than the curvature threshold, the greater the current increment.

In some embodiments, the management platform determines the current decrement based on the curvature and contact disturbance features; and determines the current increment based on the curvature and the surface roughness. More descriptions regarding the contact disturbance features may be found in the preceding related descriptions.

In some embodiments, the current decrement is positively correlated with the curvature and the contact disturbance features of the current polishing region. The greater the curvature of the current polishing region is, the steeper the curved surface (e.g., deep concave surfaces and sharp bends), the greater the current decrement, and the lower the stiffness of the polishing head, allowing the polishing head to better adapt to a contour of the steep curved surface to avoid insufficient conformity or localized over-polishing caused by excessive stiffness of the polishing head. The greater the contact disturbance features of the current polishing region, the more the polishing head is susceptible to stronger fluctuations in eccentric torque due to factors such as non-uniform contacts, edge impacts, or the like, the processor may further soften the polishing head and strengthen the buffering capability of the polishing head against instantaneous impact loads, thereby suppressing the vibration and runout during the polishing operation.

In some embodiments, the current increment is negatively correlated with the curvature of the current polishing region and positively correlated with the surface roughness. The smaller the curvature of the current polishing region (e.g., gently curved surfaces and flat surfaces), the greater the current increment, increasing the stiffness of the polishing head, providing a stronger cutting support force, and improving the polishing efficiency while ensuring polishing accuracy. The greater the surface roughness of the current polishing region, the greater the current increment, which allows for rapid removal of surface protrusion defects and improvement of the polishing efficiency.

According to some embodiments of the present disclosure, by employing the polishing head that uses the polyurethane material and has its interior filled with the magnetorheological fluid and integrated with the electromagnetic coil, the stiffness of the polishing head can be flexibly switched to adapt to different polishing regions, which significantly improves the polishing efficiency and the quality.

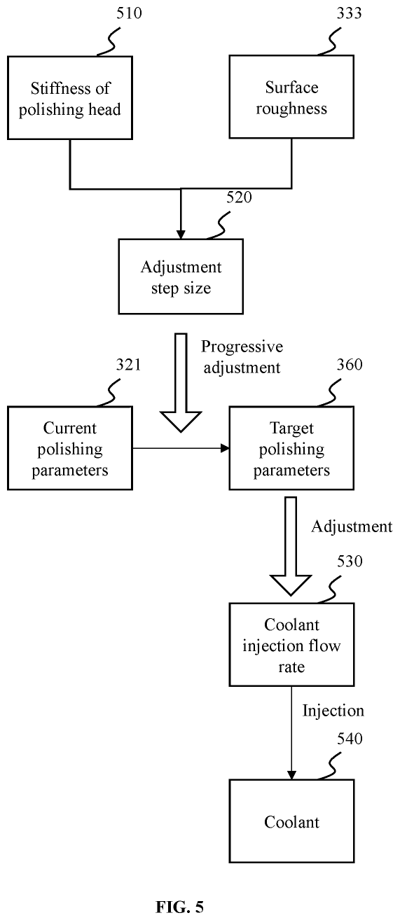

FIG. 5 is a schematic diagram illustrating an exemplary adjustment of a coolant injection flow rate according to some embodiments of the present disclosure. In some embodiments, a processor determines an adjustment step size 520 of target polishing parameters based on a stiffness 510 of a polishing head and a surface roughness 333; progressively adjusts the current polishing parameters 321 to the target polishing parameters 360 based on the adjustment step size 520; adjusts a coolant injection flow rate 530 based on the target polishing parameters 360; and controls, based on the coolant injection flow rate 530, an industrial robot to inject a coolant 540 to a current polishing region while performing a polishing operation.

The adjustment step size 520 refers to an increment or decrement of each parameter adjustment when the current polishing parameters are progressively corrected to the target polishing parameters. The adjustment step size may be represented as an adjustment speed of a polishing pressure, a feed rate, and a polishing angle.

In some embodiments, the adjustment step size 520 is positively correlated with the surface roughness of the current polishing region and negatively correlated with the stiffness of the polishing head. The greater the stiffness of the current polishing head, the more sensitive the polishing head is to force transmission response. To avoid damage to the workpiece surface, a smaller adjustment step size should be used to achieve a smooth transition of polishing parameters. The smaller the stiffness of the current polishing head, the less sensitive it is to the force transmission response, and a larger adjustment step size may be used to rapidly correct the current polishing parameters to the target polishing parameters, thereby improving the adjustment efficiency of the polishing operation. The greater the surface roughness of the current polishing region, a larger adjustment step size should be used to improve the polishing efficiency. The smaller the surface roughness of the current polishing region, indicating that a flatness of the workpiece surface is relatively high, a smaller adjustment step size should be used to avoid over-polishing affecting the workpiece surface.

In some embodiments, after the processor adjusts the stiffness of the polishing head, the adjustment step size needs to be updated in real time to avoid negative impacts such as polishing chatter, or the like, caused by polishing pressure instability.

In some embodiments, based on the adjustment step size, the processor progressively corrects the current polishing parameters until the current polishing parameters converge to within a preset error range allowed by the target parameters to perform the polishing operation.

The coolant injection flow rate 530 is configured to reflect consumption of the coolant 540. In some embodiments, the polishing process generates frictional heat, and if the heat cannot be dissipated in time, it causes a local temperature of the surface of the workpiece to sharply increase, causing the surface of the workpiece to soften and deform, and accelerating wear and passivation of the polishing head, and shortening the service life thereof. In view of this, during the polishing process, the coolant 540 may be sprayed onto the current polishing region to reduce the temperature and flush away dust debris generated by the polishing. The coolant 540 includes, but is not limited to, water, a synthetic cutting fluid, or the like.

In some embodiments, the processor may adjust the coolant injection flow rate 530 in a plurality of ways. For example, the coolant injection flow rate is positively correlated with a target polishing pressure, a target feed rate, and a target polishing angle. The greater the target polishing pressure, the higher the normal pressure between the polishing head and the current polishing region, the stronger the friction shearing effect, and the more the frictional heat generated; the faster the target feed rate, the higher the rotation speed of the polishing head, and the more the frictional heat generated; the greater the target polishing angle, the contact form between the polishing head and the workpiece transitions from surface contact to line contact or point contact, the smaller the contact area between the polishing head and the workpiece, which easily forms local hot spots, and thus requires increasing the coolant injection flow rate.

In some embodiments, at the beginning of the polishing operation, the processor may control a cooling nozzle integrated on the industrial robot to spray the coolant onto the current polishing region with a preset injection flow rate, and adjust, based on the target polishing parameters, the injection flow rate in real time during the polishing operation.

According to some embodiments of the present disclosure, progressively adjusting the current polishing parameters based on the adjustment step size ensures stability of the adjustment of the polishing parameters, and effectively avoids negative effects such as polishing chatter caused by instability of polishing pressure, or the like; adjusting the coolant injection flow rate based on the target polishing parameters achieves precise temperature control for the polishing process, avoiding thermal deformation of the workpiece surface, ensuring processing precision, and extending the service life of the polishing head.

In some embodiments, in response to determining that a decrease rate of the surface roughness is lower than a decrease rate threshold and the mechanical response data exceeds a safety threshold, the processor determines an attitude fine-tuning angle based on a count of cycles executed of the polishing operation.

The decrease rate threshold refers to a determination condition for determining whether the decrease rate of the surface roughness is abnormal. When the decrease rate of the surface roughness is lower than the decrease rate threshold, it indicates that a contact attitude between the polishing head and the workpiece may be unreasonable, or the polishing head is passivated, causing the current polishing efficiency of the polishing head to be low. More descriptions regarding the decrease rate of the surface roughness may be found in the preceding related descriptions.

The safety threshold refers to a determination condition for determining whether the mechanical response data is abnormal. When the mechanical response data exceeds the safety threshold, it indicates that a load borne by the polishing head is excessively large, which may easily cause severe consequences such as polishing chatter, workpiece scratching, polishing deformation, or the like.

In some embodiments, the mechanical response data exceeding the safety threshold refers to: an absolute value of the tangential resultant force Fₜₐₙ₍ₜ₎ exceeding a tangential resultant force threshold, or an absolute value of the resultant torque Mᵣₑₛ₍ₜ₎ exceeding a resultant torque threshold. The decrease rate threshold, the tangential resultant force threshold in the safety threshold, and the resultant torque threshold in the safety threshold may be determined based on actual application scenarios and requirements.

The attitude fine-tuning angle refers to an angle adjustment amount configured to adjust an attitude of the polishing head. In some embodiments, when the decrease rate of the surface roughness is lower than the decrease rate threshold and the mechanical response data exceeds the safety threshold, the processor may fine-tune an angle of the polishing head, thereby changing the contact form between the polishing head and the workpiece surface, and optimizing a stress distribution in a contact region.

In some embodiments, a current attitude angle of the polishing head is represented by θ, and the attitude fine-tuning angle is represented by ψ. The processor may, based on the attitude fine-tuning angle ψ, implement that the polishing head performs periodic oscillation within an angle range of [θ−ψ, θ+ψ] by adjusting a joint angle of an end effector of the industrial robot. A swing angular velocity of the polishing head may be determined based on prior experience.

In some embodiments, the processor determines the attitude fine-tuning angle based on the count of cycles executed of the polishing operation. The attitude fine-tuning angle is positively correlated with the count of cycles executed of the operations S1-S4 of the polishing operation. The more the count of cycles executed of the operations S1-S4 for the current polishing region, it indicates that the polishing efficiency in a current attitude is difficult to satisfy requirements, and even if the polishing operation is repeatedly performed for a plurality of times, an expected polishing effect has still not been achieved. At this time, the processor may increase the attitude fine-tuning angle, causing the polishing head to perform the more intense periodic oscillation, and by exploring a new contact attitude, optimizing an effective cutting contact area between the polishing head and the workpiece surface, and dispersing the load borne by the polishing head.

In some embodiments, after determining the attitude fine-tuning angle, the processor may, based on the attitude fine-tuning angle, control the polishing head to perform the periodic oscillation until the mechanical response data falls back within the safety threshold. The processor continuously monitors the mechanical response data, and in response to the mechanical response data falling back within the safety threshold, the processor ends the periodic oscillation of the polishing head.

According to some embodiments of the present disclosure, when the polishing efficiency abnormally decreases and there is a risk of force overload, the processor determines the attitude fine-tuning angle based on the count of cycles executed of the polishing operation, and based on the attitude fine-tuning angle, controls the polishing head to perform the periodic oscillation until the mechanical response data falls back within the safety threshold, which helps dynamically optimize the polishing contact state, alleviates abnormal local loads, and effectively improves polishing stability and safety.

Basic concepts have been described above. Obviously, for a person skilled in the art, the above detailed disclosure is merely by way of example, and does not constitute a limitation on the present disclosure. Although not expressly stated herein, a person skilled in the art may make various modifications, improvements, and revisions to the present disclosure. Such modifications, improvements, and revisions are contemplated in the present disclosure, and thus, such modifications, improvements, and revisions still fall within a spirit and a scope of the exemplary embodiments of the present disclosure.

Meanwhile, the present disclosure uses specific words to describe the embodiments of the present disclosure. For example, “an embodiment”, “one embodiment”, and/or “some embodiments” mean a certain feature, structure, or characteristic related to at least one embodiment of the present disclosure. Therefore, it should be emphasized and noted that references to “an embodiment” or “one embodiment” or “an alternative embodiment” at different locations for a plurality of times or twice in the present disclosure are not necessarily to the same embodiment. Furthermore, certain features, structures, or characteristics in one or a plurality of embodiments of the present disclosure may be suitably combined.

Furthermore, unless expressly stated in the claims, the order of processing elements and sequences, the use of numerals and letters, or the use of other names described in the present disclosure, is not intended to limit the order of processes and manners of the present disclosure. While some currently useful embodiments of the present disclosure have been discussed through various examples in the above disclosure, it should be understood that such details are merely for illustrative purposes, and additional claims are not limited to the disclosed embodiments; rather, the claims are intended to cover all modifications and equivalent combinations that fall within a spirit and a scope of the embodiments of the present disclosure. For example, although the system components described above may be implemented by hardware devices, they may also be implemented solely by software solutions, such as by installing the described system on an existing server or a mobile device.

Similarly, it should be noted that to simplify the description of the present disclosure, thereby facilitating an understanding of one or a plurality of embodiments of the present disclosure, in the preceding descriptions of the embodiments of the present disclosure, a plurality of features are sometimes grouped into a single embodiment, a figure, or descriptions thereof. However, this manner of disclosure does not imply that a subject matter of the present disclosure requires more features than those recited in the claims. Indeed, features of an embodiment are fewer than all the features of the single embodiment disclosed above.

In some embodiments, numerical values describing a quantity of components and attributes are used, and it should be understood that such numerical values used in the description of the embodiments are modified by the terms “about”, “approximately”, or “substantially” in some examples. Unless otherwise indicated, “about”, “approximately”, or “substantially” indicate that the stated numerical values allow for a variation of 20%. Accordingly, in some embodiments, numerical parameters used in the present disclosure and the claims are all approximate values, and such approximate values may be changed based on characteristics required by individual embodiments. In some embodiments, numerical parameters should consider specified significant digits and adopt a general manner of digit retention. Although numerical ranges and parameters used in some embodiments of the present disclosure to define a breadth of its scope are approximate values, in specific embodiments, the setting of such numerical values is as precise as possible within a feasible range.

For each patent, patent application, patent application publication, or other materials cited in the present disclosure, such as articles, books, specifications, publications, documents, or the like, the entire contents of which are hereby incorporated into the present disclosure as a reference. The application history documents that are inconsistent or conflict with the content of the present disclosure are excluded, and the documents that restrict the broadest scope of the claims of the present disclosure (currently or later attached to the present disclosure) are also excluded. It should be noted that if there is any inconsistency or conflict between the description, definition, and/or use of terms in the auxiliary materials of the present disclosure and the content of the present disclosure, the description, definition, and/or use of terms in the present disclosure is subject to the present disclosure.

Finally, it should be understood that the embodiments described in the present disclosure are merely used to illustrate principles of the embodiments of the present disclosure. Other variations may also fall within a scope of the present disclosure. Therefore, by way of example and not limitation, alternative configurations of the embodiments of the present disclosure may be regarded as consistent with teachings of the present disclosure. Accordingly, the embodiments of the present disclosure are not limited to the embodiments expressly introduced and described in the present disclosure.

What is claimed is:

1. A system for workpiece polishing based on a six-axis force sensor, comprising a management platform and a perception and control platform, wherein the perception and control platform includes a six-axis force sensor and an industrial robot,
the management platform is configured to:
determine mechanical response data of a current polishing region based on the six-axis force sensor;
determine a surface roughness of the current polishing region based on a workpiece type, current polishing parameters, and the mechanical response data;
determine target polishing parameters of the current polishing region through a first model based on the workpiece type, a curvature of the current polishing region, the surface roughness, and a target roughness, wherein the target polishing parameters include a target polishing pressure, a target feed rate, and a target polishing angle, and the first model is a machine learning model;
control the industrial robot to perform a polishing operation based on the target polishing parameters, and
cyclically perform the above operations, and, in response to determining that a difference between the surface roughness of the current polishing region and the target roughness is less than a difference threshold, control the industrial robot to move to a next polishing region to perform the polishing operation, wherein the polishing operation includes: adjusting a joint torque of the industrial robot to apply the target polishing pressure; adjusting a driving power of the industrial robot to match the target feed rate; and adjusting a joint angle of the industrial robot to align with the target polishing angle.

2. The system for workpiece polishing based on the six-axis force sensor according to claim 1, wherein an input of the first model includes a decrease rate of the surface roughness and a wear degree of a polishing head.

3. The system for workpiece polishing based on the six-axis force sensor according to claim 1, wherein the management platform is further configured to:
determine vibration features based on the mechanical response data, wherein the vibration features include friction vibration features and contact disturbance features; and
determine the surface roughness of the current polishing region through a second model based on the workpiece type, the current polishing parameters, and the vibration features, wherein the second model is a machine learning model.

4. The system for workpiece polishing based on the six-axis force sensor according to claim 3, wherein an input of the second model includes frequency domain features,
the management platform is further configured to:
determine a power spectral density function based on the mechanical response data; and
determine the frequency domain features based on the power spectral density function, wherein the frequency domain features include a spectral centroid, a spectral entropy, and a band energy ratio.

5. The system for workpiece polishing based on the six-axis force sensor according to claim 1, wherein a material of a polishing head is polyurethane, an interior of the polishing head is filled with a magnetorheological fluid and integrated with an electromagnetic coil,
the management platform is further configured to:
in response to determining that the curvature is greater than a curvature threshold, determine a current decrement of the electromagnetic coil to reduce a stiffness of the polishing head, soften the polishing head, and make the polishing head conform to the current polishing region; and
in response to determining that the curvature is less than or equal to the curvature threshold, determine a current increment of the electromagnetic coil to increase the stiffness of the polishing head, harden the polishing head, and make the polishing head cut the current polishing region.

6. The system for workpiece polishing based on the six-axis force sensor according to claim 5, wherein the management platform is further configured to:
determine the current decrement based on the curvature and contact disturbance features; and
determine the current increment based on the curvature and the surface roughness.

7. The system for workpiece polishing based on the six-axis force sensor according to claim 5, wherein the management platform is further configured to:
determine an adjustment step size of the target polishing parameters based on the stiffness of the polishing head and the surface roughness;
progressively adjust the current polishing parameters to the target polishing parameters based on the adjustment step size;
adjust a coolant injection flow rate based on the target polishing parameters; and
control, based on the coolant injection flow rate, the industrial robot to inject a coolant to the current polishing region while performing the polishing operation.

8. The system for workpiece polishing based on the six-axis force sensor according to claim 7, wherein the management platform is further configured to:
in response to determining that a decrease rate of the surface roughness is lower than a decrease rate threshold and the mechanical response data exceeds a safety threshold, determine an attitude fine-tuning angle based on a count of cycles executed of the polishing operation; and
control the polishing head to perform a periodic oscillation based on the attitude fine-tuning angle until the mechanical response data falls back within the safety threshold.

9. A method for workpiece polishing based on a six-axis force sensor, implemented by a management platform of a system for workpiece polishing based on a six-axis force sensor, the method for workpiece polishing based on the six-axis force sensor comprising:
determining mechanical response data of a current polishing region based on the six-axis force sensor;
determining a surface roughness of the current polishing region based on a workpiece type, current polishing parameters, and the mechanical response data;
determining target polishing parameters of the current polishing region through a first model based on the workpiece type, a curvature of the current polishing region, the surface roughness, and a target roughness, wherein the target polishing parameters include a target polishing pressure, a target feed rate, and a target polishing angle, and the first model is a machine learning model;
controlling an industrial robot to perform a polishing operation based on the target polishing parameters, and
cyclically performing the above operations, and in response to determining that a difference between the surface roughness of the current polishing region and the target roughness is less than a difference threshold, controlling the industrial robot to move to a next polishing region to perform the polishing operation, wherein the polishing operation includes: adjusting a joint torque of the industrial robot to apply the target polishing pressure; adjusting a driving power of the industrial robot to match the target feed rate; and adjusting a joint angle of the industrial robot to align with the target polishing angle.

10. The method for workpiece polishing based on the six-axis force sensor according to claim 9, wherein
an input of the first model includes a decrease rate of the surface roughness and a wear degree of a polishing head.

11. The method for workpiece polishing based on the six-axis force sensor according to claim 9, wherein the determining a surface roughness of the current polishing region includes:
determining vibration features based on the mechanical response data, wherein the vibration features include friction vibration features and contact disturbance features; and
determining the surface roughness of the current polishing region through a second model based on the workpiece type, the current polishing parameters, and the vibration features, wherein the second model is a machine learning model.

12. The method for workpiece polishing based on the six-axis force sensor according to claim 11, wherein an input of the second model includes frequency domain features,
the method for workpiece polishing further comprises:
determining a power spectral density function based on the mechanical response data; and
determining the frequency domain features based on the power spectral density function, wherein the frequency domain features include a spectral centroid, a spectral entropy, and a band energy ratio.

13. The method for workpiece polishing based on the six-axis force sensor according to claim 9, wherein a material of a polishing head is polyurethane, an interior of the polishing head is filled with a magnetorheological fluid and integrated with an electromagnetic coil, the method for workpiece polishing further comprising:
in response to determining that the curvature is greater than a curvature threshold, determining a current decrement of the electromagnetic coil to reduce a stiffness of the polishing head, soften the polishing head, and make the polishing head conform to the current polishing region; and
in response to determining that the curvature is less than or equal to the curvature threshold, determining a current increment of the electromagnetic coil to increase the stiffness of the polishing head, harden the polishing head, and make the polishing head cut the current polishing region.

14. The method for workpiece polishing based on the six-axis force sensor according to claim 13, further comprising:
determining the current decrement based on the curvature and contact disturbance features; and
determining the current increment based on the curvature and the surface roughness.

15. The method for workpiece polishing based on the six-axis force sensor according to claim 13, further comprising:
determining an adjustment step size of the target polishing parameters based on the stiffness of the polishing head and the surface roughness;
progressively adjusting the current polishing parameters to the target polishing parameters based on the adjustment step size;
adjusting a coolant injection flow rate based on the target polishing parameters; and
controlling the industrial robot to inject a coolant to the current polishing region while performing the polishing operation based on the coolant injection flow rate.

16. The method for workpiece polishing based on the six-axis force sensor according to claim 15, further comprising:
in response to determining that a decrease rate of surface roughness is lower than a decrease rate threshold and the mechanical response data exceeds a safety threshold, determining an attitude fine-tuning angle based on a count of cycles executed of the polishing operation; and
controlling the polishing head to perform a periodic oscillation based on the attitude fine-tuning angle until the mechanical response data falls back within the safety threshold.

17. A non-transitory computer-readable storage medium, wherein the storage medium stores computer instructions, and when a computer reads the computer instructions in the storage medium, the computer executes the method for workpiece polishing based on the six-axis force sensor according to claim 9.
